(19) United States
(12) Patent Application Publication
(10) Pub. No.: US 2001/0021466 A1
(43) Pub. Date: Sep. 13, 2001

(54) Support for magnetic recording medium and process for producing the same

(76) Inventor: Shinya Maenosono, Kanagawa-ken (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/779,746

(22) Filed: Feb. 9, 2001

(30) Foreign Application Priority Data
Feb. 10, 2000 (JP) 033519/2000

(51) Int. Cl. G11B 5/73

(52) U.S. Cl. 428/694 SG

(57) ABSTRACT

A support for a flexible magnetic recording medium made of a polyimide film obtained by coating a solution of a solvent-soluble polyimide resin on a solid substrate having a smooth surface, removing the solvent, and then peeling apart a coated film from the substrate. The support has high heat resistance and has a smooth surface, and a magnetic recording layer having high surface smoothness can be effectively formed thereon by a vacuum film-forming method such as sputtering.

### BACKGROUND OF THE INVENTION

1. Field of the Invention

The present invention relates to a support for flexible magnetic recording medium having high heat resistance and having a smooth surface suitable for forming a magnetic recording layer by a vacuum film-forming method and to a process for producing the same.

2. Description of the Prior Art

Recently, densification of a magnetic recording medium such as a hard disk, a flexible disk, and a magnetic recording tape, has been advanced. In the formation of a magnetic recording layer, for a hard disk, a solid substrate such as an aluminum substrate, a glass substrate, and an amorphous carbon substrate, is used as a support, and the layer is formed by a vacuum film-forming method such as sputtering. On the contrary, for a flexible magnetic recording medium such as a flexible disk and a magnetic recording tape, a particulate medium forming method onto a thermoplastic high-molecular support such as polyethylene terephthalate and polyethylene naphthalate, is generally used. According to the vacuum film-forming method such as sputtering, when the support surface is smooth, a thin magnetic recording layer having a smooth surface can be easily formed, and a high magnetic energy and high electro-magnetic transformation characteristics can be attained. Therefore, the vacuum film-forming method is suitable for densification. With the recent progress of densification, even on a flexible disk, a method in which a magnetic recording layer, which has hitherto been formed by the particulate medium forming method, is formed by sputtering is proposed (see, for example, Japanese Unexamined Patent Publication Nos. 10(1998)-11734, 10(1998)-198944 and 10(1998)-255252).

However, in the case where, in a magnetic recording medium having a magnetic recording layer on a flexible high-molecular support such as a flexible disk, the magnetic recording layer is formed by sputtering, thereby intending to attain densification, it is necessary to meet the following two essential requirements. That is, (1) to attain the densification by controlling morphology of the magnetic recording layer, it is necessary to heat the support during the sputtering process, and thus, the support is required to have high heat resistance; and (2) to attain high electro-magnetic transformation characteristics and reduction of dropout, the support is required to have high surface smoothness.

The requirement (1) can be attained by using a heat-resisting high-molecular material such as polyimide, polyamideimide, liquid crystal polyesters, polyphenylene sulfide, polysulfone, polyarylate, polyethersulfone, polyetherimide, polyether ether ketone, and phenol resin. But, it is generally difficult to prepare a support having high surface properties so as to satisfy the requirement (2). In the support made of a high-molecular film, precise polishing cannot be applied as the case of using an aluminum substrate or a glass substrate, and the surface properties at the preparation of the film are of a problem.

Hitherto, as a high-molecular support of a particulate type magnetic recording medium such as a flexible disk and a magnetic recording tape, a stretched film of a high-molecular material such as polyethylene terephthalate and polyethylene naphthalate, has been used as described above. But, the heat resistance of such a support is low for attaining densification by forming the magnetic recording layer by sputtering, and by heating the support, the support causes heat shrinkage or deformation, resulting in generation of a defect in the magnetic recording layer. Also, at a heating temperature of an extent of not causing heat shrinkage or deformation of the support, it is difficult to attain densification. It may be considered to use a thermosetting resin such as a phenol resin, for a reason of high heat resistance, but, in general, it is difficult to overcome defects such as deterioration in the surface properties and formation of voids in the inside of the support by gas generation accompanied by the setting reaction. Also, the mechanical characteristics such as flexibility, are not suitable for this object.

As a material simultaneously satisfying the heat resistance and the mechanical characteristics, a polyimide resin is suitable. In fact, it is proposed, for example, in Japanese Unexamined Patent Publication No.7(1995) -44857 that a polyimide film is very hopeful as a support for high-density magnetic recording medium. However, because the polyimide film is generally produced by casting, upon heating, a solution of a polyamic acid which is a polyimide precursor on a drum or a belt, peeling apart the film from the drum or belt when it has become a polyamic acid film having self supporting properties, and further heating it at a high temperature to proceed an imidation reaction (dehydration cyclization reaction), there are problems that warpage occurs due to shrinkage of the molecular structure, the surface smoothness of the drum or belt side is insufficient, surface defects by foreign matters on the drum or belt are liable to generate, and voids in the film and surface roughness of the film are liable to form. Thus, in this object, the polyimide film is insufficient from the functional viewpoints of surface smoothness and surface homogeneity.

### SUMMARY OF THE INVENTION

Under these circumstances, the present invention has been made. An object of the invention is to provide a support for a flexible magnetic recording medium having heat resistance and surface smoothness suitable for forming a magnetic recording layer by a vacuum film-forming method such as sputtering and to provide a process for producing the same.

In order to attain these objects, the present inventor made extensive investigations. As a result, it has been found that a polyimide film obtained by coating a solution of the solvent-soluble polyimide resin, for which imidation has been completed, on a solid substrate having a smooth surface; removing the solvent; and then peeling apart a coated film from the solid substrate, has a very smooth surface and satisfies a function as a support for a flexible magnetic recording medium whose magnetic recording layer is formed by sputtering, leading to accomplishment of the invention.

### DESCRIPTION OF THE PREFERRED EMBODIMENTS

The support for magnetic recording medium of the invention is comprised of a polyimide film obtained by coating a solution of a solvent-soluble polyimide resin on a solid substrate having a smooth surface, removing the solvent, and then peeling apart a coated film from the solid substrate.

It is desirable that the support has a thickness of from 3 μm to 200 μm and a glass transition temperature Tg of 200° C. or higher. Furthermore, the support preferably has a center line surface roughness Ra on both surfaces thereof of 1.5 nm or less.

On the other hand, the process for producing the support for magnetic recording medium of the invention is comprised of coating a solution of a solvent-soluble polyimide resin on a solid substrate having a smooth surface, removing the solvent, and then peeling apart a coated film, to provide a polyimide film.

In drying for removing the solvent, it is desirable that a temperature at which the drying is initiated is 20° C. or higher but lower than 150° C., and that the coated film is heated at a temperature of 200° C. or higher for at least 10 minutes during the drying process. Also, it is preferred to carry out coating of the solution of the solvent-soluble polyimide resin by a spin coating method.

The development of the polyimide solution, as the solution of the solvent-soluble polyimide resin, for which an imidation reaction has been completed, is widely carried out as shown, for example, in Japanese Patent Publication No. 5(1993)-62893, Japanese Unexamined Patent Publication Nos. 7(1995) -228857 and 11(1999) -29705, and Y. Kawashima, etal., Polyimides: Materials, Chemistry and Characterization, 123(1989). Since a polyimide film can be obtained only by removing the solvent, the surface smoothness of the polyimide film can be improved without impairing its heat resistance and mechanical characteristics, and the film can be used.

Depending upon a concentration of the solution of the solvent-soluble polyimide resin, a film thickness after removing the solvent, is reduced to from ¼ to 1/20 of the film thickness directly after coating. For using as a support for flexible sputtering type magnetic recording medium, the film thickness of the support is preferably from 3 to 200 μm, and more preferably from 30 to 150 μm. When the film thickness is thinner than 3 μm, owing to a shortage in rigidity, a curling amount by an inside stress of the sputtered film is too large. On the other hand, when the film thickness is thicker than 200 μm, owing to excessive rigidity, flexibility of the film is lost, and functional defects such as thermal asperity and dropout, are caused.

Also, to attain the final film thickness within the above-described range, the coated film thickness must be from several tens to several hundreds μm. The solution of the solvent-soluble polyimide resin has generally a high viscosity of more than several hundreds Pa·s (more than several thousands cP) For the purposes of coating such a high-viscosity liquid in a uniform thickness, though a spin coating method is suitable, a bar coating method, etc., can also be used.

According to the invention, by coating a solution of a solvent-soluble polyimide resin, for which imidation has been completed, on a solid substrate having a smooth surface, removing the solvent, and then peeling apart a coated film from the solid substrate, a polyimide film having a very smooth surface is obtained, and using the polyimide film obtained as a support for magnetic recording medium, the support has desired heat resistance and mechanical characteristics and also has a very uniform and smooth surface. Further, the polyimide film does not cause heat shrinkage and deformation during a sputtering process, and the surface smoothness of the magnetic recording layer formed on the support by sputtering is improved. Thus, a magnetic recording layer having ideal morphology and high electro-magnetic transformation characteristics are simultaneously attained, and a very high-density magnetic recording medium can be realized.

In the conventional solution film-formation by polyamic acid as a polyimide precursor, because of accompanying an imidation reaction (dehydration cyclization reaction), there are problems that formation of voids or surface roughening and warpage are liable to occur. Also, a long time is required in the heat treatment for completing the imidation reaction. However, in the case of using the polyimide resin solution, for which the imidation reaction has been completed, the polyimide film can be obtained only by removing the solvent, and the surface smoothness of the polyimide film can be improved without impairing its heat resistance and mechanical characteristics.

Also, when the film thickness of the polyimide film is from 3 to 200 μm, sufficient rigidity for forming a magnetic recording layer and flexibility for obtaining good magnetic recording characteristics can be ensured as a support for a flexible sputtering type magnetic recording medium. Furthermore, when the glass transition temperature Tg of the polyimide film is 200° C. or higher, sufficient heat resistance for forming a magnetic recording layer by a vacuum film-forming method can be ensured.

Furthermore, since the very smooth polyimide film having a center line surface roughness Ra on both surfaces thereof is 1.5 nm or less can be obtained, the smoothness of the surface of the magnetic recording layer formed thereon can be ensured, the magnetic recording characteristics are good, and reliability of high-density recording can be increased.

On the other hand, when coating of the solution of the solvent-soluble polyimide resin on a solid substrate is carried out by a spin coating method, the resin solution of a high viscosity can be coated uniformly in a thick film thickness. In an ordinary solution film-forming method by casting a solution on a drum or an endless belt, even when the solvent-soluble polyimide resin solution is used, there are problems that the surface smoothness of the film formed is insufficient, and that surface defects by foreign matters are liable to cause. However, since the spin coating method is a batch process, there are merits that a film having a very smooth surface can be coated on a solid substrate such as a silicon wafer and foreign matters can be readily removed.

Also, in the case where a flexible disk support is used as the support for magnetic recording medium, a film prepared by a continuous process must be processed into a disk form by secondary processing such as punching. But, in this case, it is possible to prepare a desired disk form (doughnut type) at the coating step by the spin coating method, and therefore, the secondary processing can be omitted. Furthermore, tracking characteristics in the case of preparing a magnetic recording medium are deteriorated when an anisotropy exists in shrinkage factor in the radius direction of the disk-form support in the sputtering process. But, in the case of the spin coating method, since in-plane isotropy in the radius direction is high as compared with that in other film-forming methods, high tracking characteristics can be expected.

Then, the present invention will be described in detail with reference to the following embodiments for the support for magnetic recording medium and the process for producing the same according to the invention.

The support for magnetic recording medium of the invention is fundamentally a flexible support in which a magnetic recording layer is formed by a vacuum film-forming method such as sputtering and is constituted of a polyimide film obtained by coating a solution of a solvent-soluble polyimide resin, for which imidation has been completed, on a solid substrate having a smooth surface, removing the solvent, and then peeling apart a coated film from the substrate. The support is formed so as to have a thickness of from 3 to 200 μm (preferably from 70 to 100 μm), a glass transition temperature Tg of 200° C. or higher, and a center line surface roughness Ra on both surfaces thereof of 1.5 nm or less within a measurement range where a measured length is 300 μm or shorter in the case of one-dimensional measurement, or within a range narrower than an area of 300 μm-square in the case of two-dimensional measurement.

In the process for producing the support, a solution of the solvent-soluble polyimide resin is coated on a solid substrate having a smooth surface by a spin coating method or a bar coring method, the solvent is removed in such a manner that drying is initiated at a temperature of 20° C. or higher but lower than 150° C., and heating is carried out at a temperature of 200° C. or higher for at least 10 minutes during the drying process accompanied by temperature raising, and the coated film is then peeled apart from the solid substrate, to obtain a polyimide film.

The solvent-soluble polyimide as referred to in the invention is a polyimide soluble in an organic solvent, which is obtained by combining one or two or more kinds of acid components, such as 3,3′,4,4′-diphenylsulfonetetracarboxylic dianhydride, 3,3′,4,4′-benzophenonetetracarboxylic dianhydride, 3,3′,4,4′-biphenylsulfonetetracarboxylic dianhydride, bis(3,4-dicarboxyphenyl) ether dianhydride, and 2,2-bis(3,4-dicarboxyphenyl)hexafluoropropane dianhydride, with one or two or more kinds of diamine components, such as 4,4′-diaminodiphenyl sulfide, 2,2-bis[4-(p-aminophenoxy)phenyl]propane, 2,2-bis[3-(p-aminophenoxy)phenyl]propane, 2,2-bis[4-(p-aminophenyl thioether)phenyl]propane, 2,2-bis[3-(p-aminophenyl thioether)phenyl]propane, 4,4′-bis(p-aminophenoxy)diphenyl, 3,3′-bis(p-aminophenoxy)diphenyl, 3,4′-bis(p-aminophenoxy)diphenyl, 4,4′-bis(p-aminophenoxy)diphenyl sulfone, 3,3′-bis(p-aminophenoxy)diphenyl sulfone, 3,4′-bis(p-aminophenoxy)diphenyl sulfone, 4,4′-bis(p-aminophenoxy)diphenyl ether, 3,3′-bis(p-aminophenoxy)diphenyl ether, 3,4′-bis(p-aminophenoxy)diphenyl ether, 4,4′-bis(p-aminophenoxy)diphenyl sulfide, 3,3′-bis(p-aminophenoxy)diphenyl sulfide, 3,4′-bis(p-aminophenoxy)diphenyl sulfide, 4,4′-bis(p-aminophenyl thioether)diphenyl, 3,3′-bis(p-aminophenyl thioether)diphenyl, 3,4′-bis(p-aminophenyl thioether)diphenyl, 4,4′-bis(p-aminophenyl thioether) diphenyl sulfone, 3,3′-bis(p-aminophenyl thioether)diphenyl sulfone, 3,4′-bis(p-aminophenyl thioether)diphenyl sulfone, 4,4′-bis(p-aminophenyl thioether)diphenyl ether, 3,3′-bis(p-aminophenyl thioether)diphenyl ether, 3,4′-bis(p-aminophenyl thioether)diphenyl ether, 4,4′-bis(p-aminophenyl thioether)diphenyl sulfide, 3,3′-bis)p-aminophenyl thioether)diphenyl sulfide, 3,4′-bis(p-aminophenyl thioether)diphenyl sulfide, 4,4′-bis(p-aminophenoxy)benzophenone, 3,3′-bis(p-aminophenoxy)benzophenone, 3,4′-bis(p-aminophenoxy)benzophenone, 4,4′-bis(p-aminophenyl thioether)benzophenone, 3,3′-bis(p-aminophenyl thioether)benzophenone, and 3,4′-bis(p-aminophenyl thioether)benzophenone.

The organic solvent as referred to in the invention includes N,N-dimethylacetamide, N,N-dimethylformamide, N,N-diethylacetamide, N,N-dimethoxyacetamide, N-methyl-2-pyrrolidone, N-ethyl-2-pyrrolidone, N-vinyl-2-pyrrolidone, dimethyl sulfoxide, 1,3-dioxane, 1,4-dioxane, acetonitrile, tetrahydrofuran, cyclohexanone, and γ-butyrolactone. These solvents may be used singly or as a mixture of two or more kinds thereof. Of these solvents, is preferred N-methyl-2-pyrrolidone. Also, the above-described organic solvent may contain an additive such as a leveling agent, etc., within the range of not impairing the objects of the invention.

The solution of the solvent-soluble polyimide resin is a solution of the solvent-soluble polyimide dissolved in the above-described organic solvent and preferably has a viscosity of from 0.1 to 40 Pa·s (1 to 400 P (poises)), and more preferably from 1 to 30 Pa·s (10 to 300 P). When the viscosity is less than 0.1 Pa·s (1 P), a thick film having a uniform thickness is hard to form, while when the viscosity exceeds 40 Pa·s (400 P), there is a problem that the workability is inferior, or the resin is deposited. Furthermore, the solvent-soluble polyimide resin used in the invention may be mixed with other thermoplastic resins such as polyether sulfone, polysulfone, polycarbonate, polyphenyl sulfide, polyetherimide, polyether ketone, polyamideimide, and polyphenylene oxide, within the range of not impairing the objects of the invention.

The solid substrate as referred to in the invention includes a solid substrate of an inorganic material, such as a silicon wafer, a glass substrate, an amorphous carbon substrate, and a stainless steel substrate, having a polished surface and having high flatness and a center line surface roughness Ra of 10 nm or less, preferably 5 nm or less, and more preferably 1.5 nm or less. Also, on the solid substrate, may be formed a thin film of other material, by a method such as vacuum vapor deposition, CVD, plasma CVD, sputtering, ion plating, and an electrochemical deposition method, within the range of not impairing the objects of the invention. Such a thin film is preferably made of a material that the resistance (adhesion) during peeling apart the polyimide film after forming the polyimide film is low.

There are no particular restrictions on the conditions of the film-forming method such as a spin coating method, and the conditions differ depending upon the viscosity of the solvent-soluble polyimide solution, the desired thickness of the support, etc. It is preferred that a solvent vapor pressure of the atmosphere in the coating process is controlled. More preferably, a saturated vapor pressure of the solvent is maintained during coating, and the coating process is separated from the drying process as completely as possible.

The solvent removal in the invention is carried out by heating in a dryer, such as a constant-temperature dryer, a clean oven, and a reduced pressure dryer, and in this case, the drying conditions are set such that the temperature at the initiation of drying is 20° C. or higher but lower than 150° C., and during the drying process, the coated film is heated at a temperature of 200° C. or higher for at least 10 minutes. When the temperature at the initiation of drying is lower than 20° C., the solution is hard to be evaporated, and the drying time becomes too long as well as the coated film is possibly deteriorated by moisture absorption, etc. When the temperature is 150° C. or higher, shrinkage of the coated film surface by the rapid evaporation of the solvent occurs, and the flatness and the surface smoothness are deteriorated. Accordingly, it is desirable that for a while from the initiation of drying, the film is dried at a low temperature (20 to 150° C.), and when the drying proceeds to some extent, the temperature is raised, and the film is heated to a temperature of 200° C. or higher for at least 10 minutes. When the drying is finished without raising the drying temperature, and the amount of the residual solvent in the film becomes large, whereby the solvent removal occurs in the chamber of a sputtering apparatus, thereby staining the chamber. It is better that the drying temperature is preferably raised to a temperature near the glass transition temperature Tg. Also, a method of drying by approaching a heater such as a hot plate from an opposite side of the solid substrate to the coated film may be employed within the range of not impairing the objects of the invention.

Because the surface of the polyimide film support thus formed is very smooth, when a thin film of a ferromagnetic metal is formed on the support by sputtering, very high electro-magnetic transformation characteristics are obtained owing to the surface smoothness of the support. Thus, a flexible magnetic recording medium having a high-density recording properties, which has never been obtained, can be realized. In addition, for the purposes of improving sliding properties and running durability, a layer containing inorganic fine particles may be formed on the surface of the support by the method shown, for example, in Japanese Unexamined Patent Publication No. 8(1996)-185619, within the range of not impairing the objects of the invention.

The support for magnetic recording medium of the invention may further contain known additives such as a thermal stabilizer, an anti-oxidation stabilizer, a photo stabilizer, and a ultraviolet absorbent, within the range of not impairing the objects of the invention.

The magnetic recording layer of a high-density magnetic recording medium to which the support for magnetic recording medium of the invention is applied is a laminated layer film including a thin-film layer of a ferromagnetic metal formed by a vacuum film-forming method such as sputtering (other layers are, for example, a subbing layer, a non-magnetic layer, a protective layer, etc.), and when the magnetic recording layer contains at least one layer of the ferromagnetic metal thin-film layer, there are no particular restrictions on the layer construction and the film thickness.

Then, while showing the Examples and Comparative Examples of the invention, the surface properties are evaluated. However, it should not be construed that the invention is limited thereto.

### EXAMPLE 1

A solution of 20% by weight of a solvent-soluble polyimide obtained by polycondensation reaction of 3,3′,4,4′-diphenylsulfonetetracarboxylic dianhydride (DSDA) with an aromatic diamine, in NMP (N-methyl-2-pyrrolidone) (Rikacoat SN-20, manufactured by New Japan Chemical Co., Ltd.), was allowed to stand in a cold-dark place for 24 hours to remove bubbles and then coated on a (100) plane of a silicon wafer (solid substrate) having a diameter of 8.9 cm (3.5 inches) by a bar coating method.

Thereafter, the coated film was pre-dried in a clean oven at 50° C. for one hour; the temperature was raised to 150° C. at a temperature-raising rate of 3.0° C./minute; the film was dried at 150° C. for one hour; and the temperature was then raised to 250° C. at a temperature-raising rate of 3.0° C./minute, to form a polyimide film having a final film thickness of about 70 μm on the silicon wafer.

The polyimide film was carefully peeled apart from the silicon wafer, and the surface was evaluated by a measuring instrument, AFM (manufactured by Digital Instrument Corporation) and TOPO-3D (manufactured by WYKO Corporation). The evaluation results (surface roughness Ra) are shown in Table 1. Also, the results of the projection distribution analysis by AFM are shown in Table 2.

In AFM, a one-dimensional measurement is carried out, and in TOPO-3D, a two-dimensional measurement is carried out. The measuring range of the center line surface roughness Ra in Table 1 is 30×30 μm in AFM and is 242×184 μm in TOPO-3D, respectively. Also, the projection distribution in Table 2 is a total number of the projections of the heights of at least 5, 10, 15, . . . , 35 nm from the center line detected by the AFM measurement within the region of 30×30 μm. For example, when one projection having each of the heights of 7 nm, 12 nm, and 28 nm exists, the results shown in the column “Example” in Table 2 are obtained.

### EXAMPLE 2

A solution of a solvent-soluble polyimide was allowed to stand in a cold-dark place for 24 hours to remove bubbles in the same manner as in Example 1. The solution was then coated on a (100) plane of a silicon wafer having a diameter of 12.7 cm (5 inches) by a spin coating method. A revolution number of the substrate at the coating was 250 rpm, and a revolution time was 50 seconds.

Thereafter, the coated film was pre-heated in a clean oven at 50° C. for one hour; the temperature was raised to 200° C. at a temperature-raising rate of 2.5° C./minute; the coated film was dried at 200° C. for one hour; and the temperature was then raised to 280° C. at a temperature-raising rate of 2.3° C./minute, to form a polyimide film having a final film thickness of about 100 μm on the silicon wafer. The polyimide film was carefully peeled apart from the silicon wafer, and the surface thereof was evaluated by AFM and TOPO-3D in the same manner as in Example 1. The evaluation results (surface roughness Ra) are shown in Table 1. Also, the results of the projection distribution analysis by AFM are shown in Table 2.

### EXAMPLE 3

A solution of a solvent-soluble polyimide was allowed to stand in a cold-dark place for 24 hours to remove bubbles in the same manner as in Example 1. The solution was then coated on a (100) plane of a silicon wafer having a diameter of 12.7 cm (5 inches) by a spin coating method. A revolution number of the substrate at the coating was 150 rpm, and a revolution time was 100 seconds.

Thereafter, the coated film was pre-heated in a clean oven at 50° C. for one hour; the temperature was raised to 200° C. at a temperature-raising rate of 2.5° C./minute; the coated film was dried at 200° C. for one hour; and the temperature was raised to 280° C. at a temperature-raising rate of 2.3° C./minute, to form a polyimide film having a final film thickness of about 140 μm on the silicon wafer. The polyimide film was carefully peeled apart from the silicon wafer, and the surface thereof was evaluated by AFM and TOPO-3D in the same manner as in Example 1. The evaluation results (surface roughness Ra) are shown in Table 1. Also, the results of the projection distribution analysis by AFM are shown in Table 2.

### COMPARATIVE EXAMPLES 1 TO 3

In these Comparative Examples, were used commercially available polyimide films manufactured by Mitsubishi Chemical Corporation, Lot. A1108C (thickness: 51 μm) in Comparative Example 1, Lot. A1094B (thickness: 51 μm) in Comparative Example 2, and Lot. A1096B (thickness: 72 μm) in Comparative Example 3, respectively. These films were formed by a continuous process using a solution of polyamic acid. The surfaces of the films were evaluated by TOPO-3D. The evaluation results (surface roughness Ra) are shown in Table 1. Also, the results of the projection distribution analysis by AFM are shown in Table 2.

### COMPARATIVE EXAMPLE 4

In this Comparative Example, was used a commercially available polyimide film, Lot. 50S510 (thickness: 50 μm) manufactured by Ube Industries, Ltd., and the surface thereof was evaluated by TOPO-3D. The evaluation results (surface roughness Ra) are shown in Table 1. Also, the results of the projection distribution analysis by AFM are shown in Table 2.

### COMPARATIVE EXAMPLE 5

In this Comparative Example, was used a commercially available polyethylene naphthalate film having a thickness of 50 μm manufactured by Teijin Limited, and the surface thereof was evaluated by TOPO-3D. The evaluation results (surface roughness Ra) are shown in Table 1.

### COMPARATIVE EXAMPLE 6

In this Comparative Example, was used a commercially available polyimide film ((Kapton, thickness: 47.2 μm) manufactured by Du Pont-Toray Co., Ltd.), and the surface thereof was evaluated by TOPO-3D. The evaluation results (surface roughness Ra) are shown in Table 1.

### COMPARATIVE EXAMPLES 7 and 8

In these Comparative Examples, were used commercially available polyphenylene sulfide films manufactured by Toray Industries, Ltd., one having a thickness was 50 μm in Comparative Examples 7 and one having a thickness of 73 μm in Comparative Examples 8, respectively, and the surfaces thereof were evaluated by TOPO-3D. The evaluation results (surface roughness Ra) are shown in Table 1.

### COMPARATIVE EXAMPLES 9 AND 10

In these Comparative Examples, were used commercially available aramide films (Aramica) manufactured by Asahi Kasei Corporation, one having a thickness of 38 μm in Comparative Examples 9 and one having a thickness of 50 μm in Comparative Examples 10, respectively, and the surfaces thereof were evaluated by TOPO-3D. The evaluation results (surface roughness Ra) are shown in Table 1.

From the results of Table 1, in each of Comparative Examples 1 to 10, the center line surface roughness Ra is large as exceeding 1.5 nm in the two-dimensional measurement, while in Examples 1 to 3 of the invention, the surface roughness Ra is small as lower than 1 nm, and good surface smoothness is obtained in each of the Examples. Also, from the results of Table 2, in the projection distribution, in Comparative Examples 1 to 4, projections of not higher than 15 nm are remarkably generated at both the surfaces of each film and are particularly remarkable at the solid substrate side of each film, while in Examples 1 to 3 of the invention, the whole number of the projections including low ones is a number of one figure, appearance of the high projections exceeding 20 nm is very small, and high smoothness is obtained. Thus, in the Examples of the invention, the surface smoothness in the case of forming a magnetic recording layer can be ensured, and each magnetic recording layer can cope with densification.

TABLE 1

| | Ra (nm) at free surface side | | Ra (nm) at solid substrate side | |
|---|---|---|---|---|
| | AFM | TOPO-3D | AFM | TOPO-3D |
| Example 1 | 0.325 | 0.73 | 0.296 | 0.84 |
| Example 2 | 0.310 | 0.75 | 0.285 | 0.74 |
| Example 3 | 0.340 | 0.86 | 0.304 | 0.71 |
| Comparative | — | 1.69 | — | 1.82 |
| Example 1 | | | | |
| Comparative | — | 3.00 | — | 2.71 |
| Example 2 | | | | |
| Comparative | — | 1.90 | — | 2.73 |
| Example 3 | | | | |
| Comparative | — | 1.59 | — | 1.60 |
| Example 4 | | | | |
| Comparative | — | 3.83 | — | 4.02 |
| Example 5 | | | | |
| Comparative | — | 14.6 | — | 34.2 |
| Example 6 | | | | |
| Comparative | — | 9.0 | — | 11.0 |
| Example 7 | | | | |
| Comparative | — | 18.0 | — | 16.0 |
| Example 8 | | | | |
| Comparative | — | 3.46 | — | 4.30 |
| Example 9 | | | | |
| Comparative | — | 2.66 | — | 1.50 |
| Example 10 | | | | |

TABLE 2

| Height (nm) of Projection | | 5 | 10 | 15 | 20 | 25 | 30 | 35 |
|---|---|---|---|---|---|---|---|---|
| Example | | 3 | 2 | 1 | 1 | 1 | 0 | 0 |
| Example 1 | Free surface side | 1 | 0 | 0 | 0 | 0 | 0 | 0 |
| | Solid substrate side | 7 | 3 | 1 | 1 | 1 | 1 | 1 |
| Example 2 | Free surface side | 0 | 0 | 0 | 0 | 0 | 0 | 0 |
| | Solid substrate side | 4 | 4 | 3 | 2 | 1 | 1 | 1 |
| Example 3 | Free surface side | 4 | 2 | 2 | 1 | 1 | 0 | 0 |
| | Solid substrate side | 1 | 1 | 1 | 1 | 1 | 0 | 0 |
| Comparative | Free surface side | 157 | 25 | 19 | 8 | 5 | 2 | 2 |
| Example 1 | Solid substrate side | 3887 | 1688 | 134 | 7 | 5 | 3 | 2 |
| Comparative | Free surface side | 184 | 65 | 34 | 25 | 11 | 3 | 2 |
| Example 2 | Solid substrate side | 2158 | 1919 | 808 | 100 | 12 | 2 | 1 |
| Comparative | Free surface side | 168 | 58 | 11 | 8 | 2 | 2 | 2 |
| Example 3 | Solid substrate side | 2263 | 2263 | 714 | 73 | 5 | 1 | 0 |
| Comparative | Free surface side | 802 | 103 | 37 | 24 | 12 | 10 | 8 |
| Example 4 | Solid substrate side | 3312 | 1944 | 369 | 30 | 3 | 0 | 0 |

What is claimed is:

1. A support for magnetic recording medium, comprising a polyimide film obtained by coating a solution of a solvent-soluble polyimide resin on a solid substrate having a smooth surface, removing the solvent, and then peeling apart a coated film from the solid substrate.

2. The support for magnetic recording medium according to claim 1, wherein the film has a center line surface roughness on both surfaces thereof is 1.5 nm or less.

3. The support for magnetic recording medium according to claim 1, wherein the film has a glass transition temperature of 200° C. or higher.

4. The support for magnetic recording medium according to claim 3, wherein the film has a center line surface roughness on both surfaces thereof is 1.5 nm or less.

5. The support for magnetic recording medium according to claim 1, wherein the film has a thickness of from 3 μm to 200 μm.

6. The support for magnetic recording medium according to claim 5, wherein the film has a center line surface roughness on both surfaces thereof is 1.5 nm or less.

7. The support for magnetic recording medium according to claim 5, wherein the film has a glass transition temperature of 200° C. or higher.

8. The support for magnetic recording medium according to claim 7, wherein the film has a center line surface roughness on both surfaces thereof is 1.5 nm or less.

9. A process for producing a support for magnetic recording medium, which comprises coating a solution of a solvent-soluble polyimide resin on a solid substrate having a smooth surface, removing the solvent, and then peeling apart a coated film from the substrate, to provide a polyimide film.

10. The process for producing a support for magnetic recording medium according to claim 9, wherein the coating of the solution of the solvent-soluble polyimide resin is carried out by a spin coating method.

11. The process for producing a support for magnetic recording medium according to claim 9, wherein in drying for removing the solvent, a temperature at which the drying is initiated is 20° C. or higher but lower than 150° C., and the coated film is heated at a temperature of 200° C. or higher for at least 10 /minute during the drying process.

12. The process for producing a support for magnetic recording medium according to claim 11, wherein the coating of the solution of the solvent-soluble polyimide resin is carried out by a spin coating method.
